(19) United States
(12) Patent Application Publication
(10) Pub. No.: US 2019/0267007 A1
(43) Pub. Date: Aug. 29, 2019

(54) TEXT CORRECTION APPARATUS AND TEXT CORRECTION METHOD

(71) Applicant: FUJITSU LIMITED, Kawasaki-shi (JP)

(72) Inventors: Satoru Sankoda, Kawasaki (JP); Kousuke Iemura, Kawasaki (JP); Shinobu Tokita, Kawasaki (JP)

(73) Assignee: FUJITSU LIMITED, Kawasaki-shi (JP)

(21) Appl. No.: 16/279,023

(22) Filed: Feb. 19, 2019

(30) Foreign Application Priority Data
Feb. 27, 2018 (JP) 2018-032888

(51) Int. Cl. G10L 15/26; G10L 15/02; G10L 15/22; G06N 20/00

(52) U.S. Cl. CPC G10L 15/265; G10L 15/02; G10L 2015/225; G06N 20/00; G10L 15/22

(57) ABSTRACT

A text correction apparatus includes a memory; and a processor coupled to the memory and configured to divide sentence data recognized from speech data into a plurality of text units, when selection of one text unit among the plurality of divided text units is input via an input device, determine the selected text unit as a correction target, display the selected text unit in a correctable state on a display device, and reflect correction in the sentence data on the display device in accordance with correction of the selected text unit.

### CROSS-REFERENCE TO RELATED APPLICATION

This application is based upon and claims the benefit of priority of the prior Japanese Patent Application No. 2018-32888, filed on Feb. 27, 2018, the entire contents of which are incorporated herein by reference.

### FIELD

The embodiments discussed herein are related to a text correction apparatus and a text correction method.

### BACKGROUND

Converting speech data into text is referred to as, for example, transcript generation. The method for generating a transcript from speech data includes manual transcript generation and automatic transcript generation with the use of speech recognition technology.

In manual transcript generation, a computer operator inputs characters corresponding to speech by using an input device such as a keyboard while listening to the speech being reproduced, and the computer generates text data based on the input via the input device. In automatic transcript generation with the use of speech recognition technology, a computer automatically converts speech into text by recognizing audio corresponding to speech data.

As one of the technologies of the related art, there is proposed a technology in which actual speech is recognized by utilizing a grammar model that includes undesired words and that is generated from transcript text not including undesired words.

The technologies of the related art are disclosed in Japanese Laid-open Patent Publication Nos. 2018-4947, 09-190436, and 2009-217665.

### SUMMARY

According to an aspect of the embodiments, a text correction apparatus includes a memory; and a processor coupled to the memory and configured to divide sentence data recognized from speech data into a plurality of text units, when selection of one text unit among the plurality of divided text units is input via an input device, determine the selected text unit as a correction target, display the selected text unit in a correctable state on a display device, and reflect correction in the sentence data in accordance with correction of the selected text unit.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates an example of a text correction apparatus;

FIG. 2 illustrates an example of a screen displayed on a display (part 1);

FIG. 3 illustrates an example of a screen displayed on the display (part 2);

FIG. 4 is a flowchart illustrating an example of a processing flow when one piece of sentence data is selected;

FIG. 5 illustrates an example of a component table;

FIG. 6 is a flowchart (part 1) illustrating a processing flow when a key is input in a first example;

FIG. 7 is a flowchart (part 2) illustrating the processing flow when a key is input in the first example;

FIG. 8 is a flowchart (part 1) illustrating a processing flow when a key is input in a second example;

FIG. 9 is a flowchart illustrating an example of a timer event handler processing flow;

FIG. 10 illustrates an example of a time table;

FIG. 11 is a flowchart (part 2) illustrating a processing flow when a key is input in a second example;

FIG. 12 illustrates an example of calculation using a learned model;

FIG. 13 illustrates an example of a screen displayed on the display (part 3);

FIG. 14 illustrates an example of a screen displayed on the display (part 4);

FIG. 15 is a flowchart (part 1) illustrating a processing flow when a key is input in a third example;

FIG. 16 is a flowchart (part 2) illustrating the processing flow when a key is input in the third example;

FIG. 17 illustrates an example of a screen displayed on the display (part 5);

FIG. 18 illustrates an example of a screen displayed on the display (part 6);

FIG. 19 is a flowchart illustrating an example of a processing flow in a second embodiment;

FIG. 20 is a flowchart illustrating an example of a correction mode processing flow;

FIG. 21 illustrates an example of a hardware configuration of the text correction apparatus; and

FIG. 22 illustrates an example of a screen displayed on the display (part 7).

### DESCRIPTION OF EMBODIMENTS

In a case of manual transcript generation, for example, typographic errors or kanji conversion error made by an operator may result in generation of text data that includes an error word and whose meaning differs from that of the original. In a case of the automatic transcript generation with the use of speech recognition technology, a word may be erroneously recognized as a result of speech recognition of speech data. Such a case also results in generation of text data including an error word. Such error words are desired to be corrected.

The correction of error words is performed by a computer operator via a keyboard. One sentence includes multiple words. The operator moves a text cursor to an error word by using a keyboard, deletes the error word, and replaces the error word with a correct word. When there are multiple error words, the above-described operation is repeated multiple times.

In some cases, it may be difficult to decipher words by reproducing speech only once. In this case, the operator repeatedly reproduces audio corresponding to a word targeted for correction and corrects the word. As described above, correction for the result of speech transcript generation tends to be a complex operation.

### First Embodiment

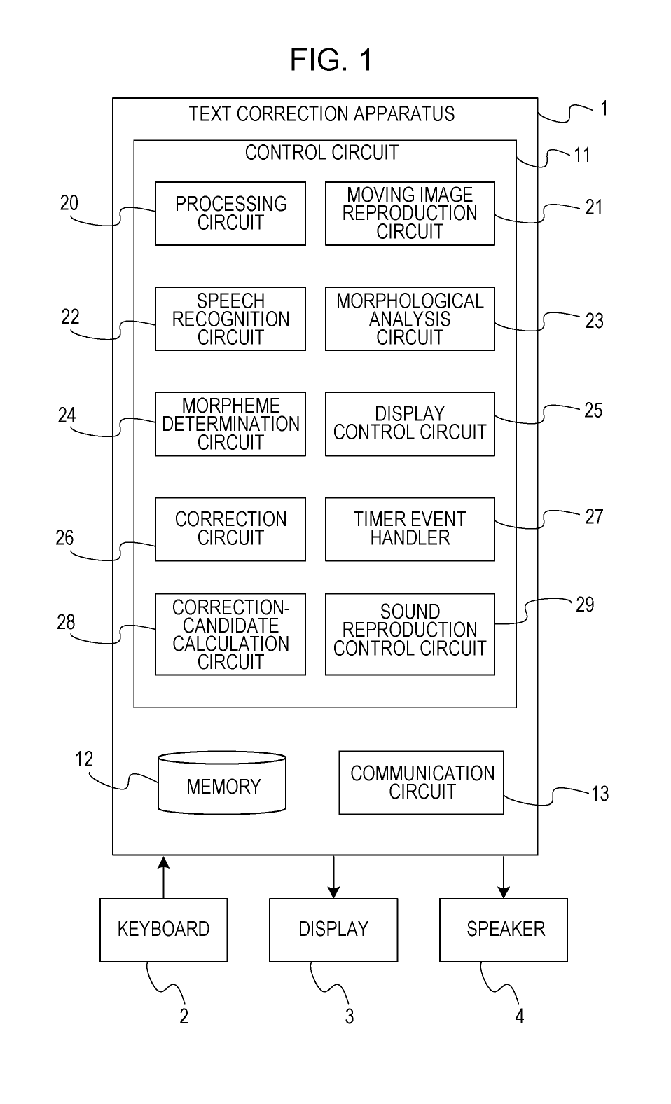

Referring to FIG. 1, a text correction apparatus of a first embodiment is described. A text correction apparatus 1 is used for, for example, correcting and editing words and the like included in sentence data based on speech data.

For example, the text correction apparatus 1 is used for correcting audio captions in moving image data containing speech data. The text correction apparatus 1 may be used for, for example, correcting captions in television broadcasting. The text correction apparatus 1 is, for example, a personal computer and is an example of a computer.

A keyboard 2, a display 3, and a speaker 4 are connected to the text correction apparatus 1. In the first embodiment and in a second embodiment, it is assumed that input to the text correction apparatus 1 is performed via an input device such as the keyboard 2.

In the following description, it is assumed that the text correction apparatus 1 recognizes audio corresponding speech data and converts the speech data into text. The text correction apparatus 1 may convert speech data into text such that an operator (hereinafter referred to as a user) who operates the text correction apparatus 1 performs input on the keyboard 2 of characters corresponding to sound of audio while listening to the audio of the speech data.

The text correction apparatus 1 may also convert speech data into text, for example, such that a user enters via the input device such as the keyboard 2 characters corresponding to sound of audio while listening to the audio of speech data recorded on tape. The text correction apparatus 1 may also convert speech data into text, for example, such that a user inputs on the keyboard 2 characters corresponding to sound of audio while listening to speech at a meeting or the like.

Both the sentence data obtained by converting speech into text by using speech recognition technology and the sentence data obtained by a user inputting characters on the keyboard 2 are sentence data based on speech data. The sentence data is text data.

The text correction apparatus 1 includes a control circuit 11, a memory 12, and a communication circuit 13. The control circuit 11 includes a processing circuit 20, a moving image reproduction circuit 21, a speech recognition circuit 22, a morphological analysis circuit 23, a morpheme determination circuit 24, a display control circuit 25, a correction circuit 26, a timer event handler 27, a correction-candidate calculation circuit 28, and a sound reproduction control circuit 29.

The memory 12 stores data corresponding to multiple kinds of information such as moving image data containing speech data, sentence data based on speech data, and table data. The communication circuit 13 communicates with an external server and the like via a network.

The processing circuit 20 performs various types of processing. The moving image reproduction circuit 21 controls reproduction of moving image data stored in the memory 12. Under this control, a moving image is reproduced on a screen of the display 3 and sound is reproduced by the speaker 4. The speech recognition circuit 22 recognizes the speech portion in moving image data and converts the speech into text. The memory 12 stores the sentence data obtained by converting the sounds into text. In such a manner, a transcript of the speech portion of the moving image data is generated.

The morphological analysis circuit 23 analyzes the sentence data and divides the sentence data into multiple morphemes. Each morpheme is an example of a text unit. The sentence data may be divided into words, phrases, or the like. In such cases, a word, a phrase, or the like corresponds to a text unit.

The morpheme determination circuit 24 identifies a morpheme, among multiple morphemes, designated as a correction target by a user operation. The morpheme determination circuit 24 is an example of a determination circuit.

The display control circuit 25 controls displaying on the screen of the display 3 as a display device. The correction circuit 26 reflects correction in a morpheme in accordance with correction details that are input via the input device such as the keyboard 2 by a user operating the text correction apparatus 1.

The timer event handler 27 performs processing for an event at regular intervals that are measured by an interval timer provided to the text correction apparatus 1.

The correction-candidate calculation circuit 28 calculates, in accordance with a learned model obtained by machine learning that uses multiple pieces of past sentence data as input data, a correction candidate with respect to a correction-target morpheme among multiple morphemes included in sentence data that is targeted for correction. The sound reproduction control circuit 29 controls a playback speed of the sound corresponding to a morpheme or the like that is reproduced by the speaker 4.

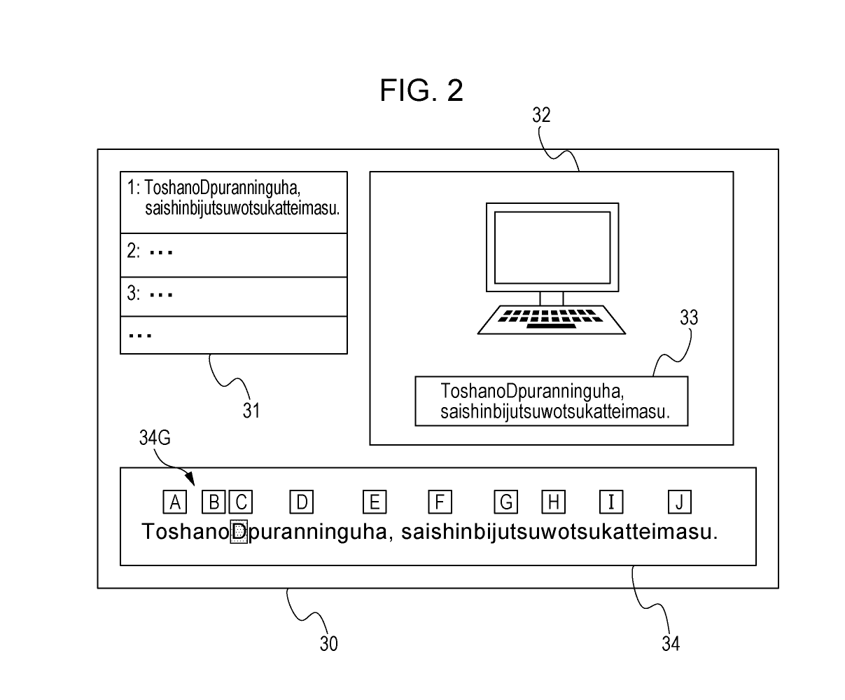

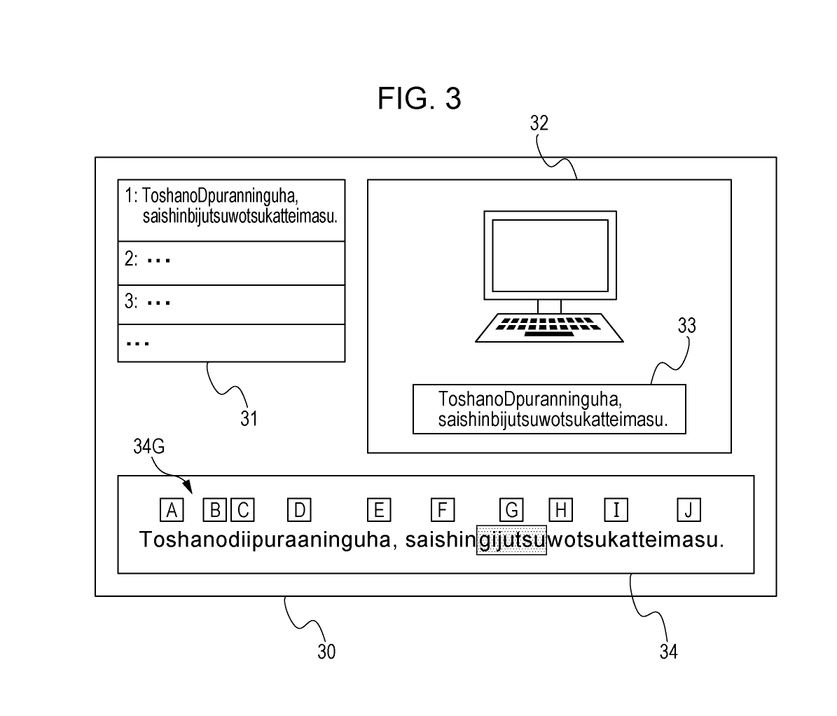

FIGS. 2 and 3 illustrate examples of a screen displayed on the display 3 as the display device in the first embodiment. FIG. 2 illustrates an example of a screen before correcting sentence data, and FIG. 3 illustrates an example of a screen after correcting the sentence data. A screen 30 is a screen displayed on the display 3. The screen 30 includes a sentence data display area 31, a moving image display area 32, a text display area 33, and a text correction area 34.

Multiple pieces of sentence data are selectably displayed in the sentence data display area 31. For example, when speech data contained in one piece of moving image data is converted into text, multiple pieces of sentence data are generated. Hereinafter, it is assumed that one piece of sentence data is denoted by a single character string between two periods, but one piece of sentence data may be denoted by multiple character strings each enclosed by two periods. In FIG. 2, it is assumed that a sentence “ToshanoDpuranninguha, saishinbijutsuwotsukatteimasu.” (“D planning of our company uses the latest art.”) is selected.

The moving image display area 32 is an area where the moving image reproduction circuit 21 causes moving image data to be displayed and a moving image is reproduced in the moving image display area 32. The text display area 33 is an area where sentence data (sentences of a generated transcript) is displayed, in which the sentence data is obtained by the speech recognition circuit 22 recognizing a speech portion of moving image data being reproduced and converting the recognized speech portion into text. The text display area 33 is, for example, a caption area.

The text correction area 34 is an area where correction of morphemes included in the sentence data is performed. The same sentence data as in the text display area 33 is displayed in the text correction area 34. The sentence data displayed in the text correction area 34 is correctable.

The text correction area 34 includes a guide display area 34G. In the guide display area 34G, shortcut keys corresponding to respective morphemes obtained by morphological analysis using the sentence data are displayed. The shortcut keys are an example of identification information or element for identifying morphemes.

In FIG. 2, the sentence data “ToshanoDpuranninguha, saishinbijutsuwotsukatteimasu.” is divided into ten morphemes from “tosha” to “imasu”. A shortcut key A is associated with “tosha” and a shortcut key J is associated with “imasu”. The display control circuit 25 displays in the text correction area 34 of the display 3 the shortcut keys in association with the respective morphemes.

The state of each morpheme is switched between a normal mode and a correction mode. The normal mode is a mode in which a morpheme is not correctable. The correction mode is a mode in which a morpheme is correctable.

In FIG. 2, it is assumed that “D puranningu” is an error of “deep learning” and “bijutsu” (“art” in English) is an error of “gijutsu” (“technology” in English). These errors result from errors in speech recognition performed by the speech recognition circuit 22. In a case of inputting on the keyboard 2 by a user, the errors result from a mistake in key operation, a conversion error, or the like.

In the normal mode, in a case where a user operating the text correction apparatus 1 corrects the error of a morpheme “D” by using the keyboard 2, the user inputs a key C. When the key C is input, the keyboard 2 outputs to the text correction apparatus 1 a signal indicating the input of the key C.

The processing circuit 20 of the text correction apparatus 1 detects the input of the key C in accordance with the signal. In accordance with the detection, the morpheme determination circuit 24 determines that the morpheme “D” corresponding to a shortcut key C is selected as a correction target.

In response to the detection of the input of the key C, the state of the morpheme “D” corresponding to the shortcut key C is switched from the normal mode to the correction mode. This enables correction of the morpheme “D”.

At this time, the display control circuit 25 displays in an emphasized manner the morpheme “D” corresponding to the shortcut key C. In this manner, the state of the morpheme “D” is changed to a selected state, and as a result, the morpheme targeted for correction is visually presented. In the example in FIG. 2, the selected portion is indicated by dots.

In the following description, it is assumed that the display control circuit 25 displays a correction-target morpheme in an emphasized manner (for example, change in color or change in a background color), but the display control circuit 25 may change the state of a correction target to an arbitrary display mode.

When the state of a selected morpheme is changed from the normal mode to the correction mode, the state of the correction-target morpheme (a morpheme corresponding to a key that has been input) may be changed to an overwrite mode. The overwrite mode serving as the correction mode enables the operation for deleting an erroneous morpheme to be omitted, thereby reducing the workload for correcting the result of transcript generation.

As described above, the morpheme “D” is selected in FIG. 2. The text correction apparatus 1 receives a user input of “dii” that is input by using the keyboard 2. In response to this, the correction circuit 26 changes the character of the morpheme “D” to the characters “dii”.

The morpheme “puranningu” is correctly “puranningu”. When the user corrects the morpheme “puranningu”, the user may select the correction-target morpheme “puranningu” by inputting key “D” or a special operation key. The special operation key is, for example, the tab key.

For example, the morpheme “puranningu” directly follows the morpheme “D”. In this case, after the morpheme “D” is corrected, when input of the tab key for selecting a subsequent morpheme is detected, the morpheme determination circuit 24 determines the morpheme “puranningu” as the selected correction target.

Accordingly, when the text correction apparatus 1 receives an input of the tab key while the morpheme “D” corresponding to the shortcut key C is being selected, the display control circuit 25 controls display of the subsequent morpheme “puranningu” as a correction target in an emphasized manner.

The user inputs “puranningu” by using the keyboard 2, and the text correction apparatus 1 receives the input. In such a manner, the correction circuit 26 changes the characters of the morpheme “puranningu” to the characters of “puranningu”.

As described above, “bijutsu” is an error of “gijutsu”. In the normal mode, when the user inputs via the keyboard 2 a key G corresponding to the shortcut key G, the input of the key G is detected.

The display control circuit 25 displays in an emphasized manner a morpheme “bijutsu” corresponding to the shortcut key G as a correction target. Accordingly, the morpheme “bijutsu” becomes correctable. The user inputs “gijutsu” by using the keyboard 2, and the text correction apparatus 1 receives the input. In such a manner, the correction circuit 26 changes the characters of the morpheme “bijutsu” to the characters of “gijutsu”.

As a result of the above-described corrections, as illustrated in FIG. 3, the sentence of the sentence data before correction “ToshanoDpuranninguha, saishinbijutsuwotsukatteimasu.” is changed to the correct sentence of the sentence data “Toshanodiipuraaninguha, saishingijutsuwotsukatteimasu.”.

As described above, the shortcut keys are displayed in association with the respective morphemes in the text correction area 34. The shortcut keys correspond to respective keys on the keyboard 2. In the displayed sentence of the sentence data, when a key input of a shortcut key corresponding to an erroneous morpheme is detected, the morpheme determination circuit 24 determines the correction-target morpheme in accordance with the input key.

If the sentence of the sentence data is corrected on a character-by-character basis by operating an arrow key of the keyboard 2, the operation for moving the text cursor to a correction portion is desired, thereby resulting in a complex correction operation.

In the first embodiment, as described above, a correction-target morpheme is able to be selected by using a shortcut key, thereby reducing the workload for correcting the sentence data (the result of transcript generation) displayed in the text correction area 34.

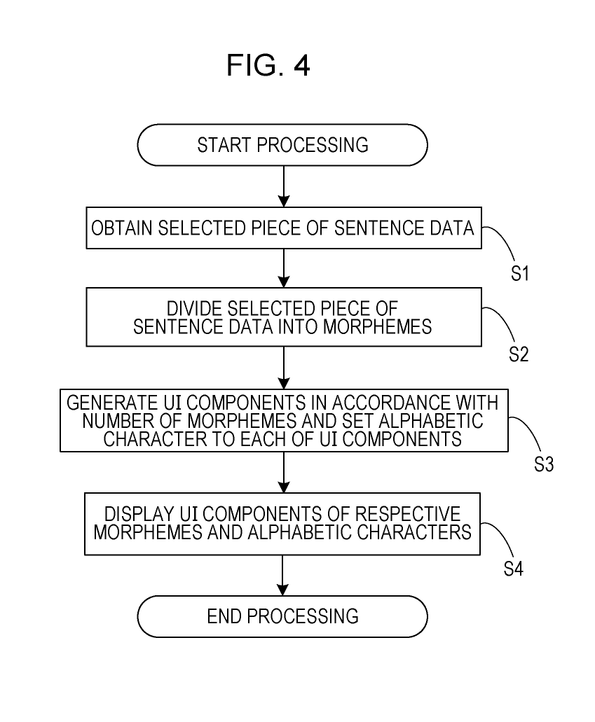

Next, referring to FIG. 4, a processing flow when a single piece of sentence data is selected is described. As described above, multiple pieces of sentence data are displayed in the sentence data display area 31 of the screen 30.

The user selects any of the multiple pieces of the sentence data contained in the sentence data display area 31 by using the keyboard 2, and the selection operation is detected. In response to the detection of the selection operation, the morphological analysis circuit 23 obtains the selected piece of the sentence data from the memory 12 (step S1).

The morphological analysis circuit 23 analyzes the selected piece of the sentence data obtained in step S1 and divides the selected piece of the sentence data into multiple morphemes (step S2). The display control circuit 25 generates user interface (UI) components in accordance with the number of the morphemes obtained by dividing the selected piece of the sentence data in step S2. The UI component is used for displaying morphemes and correcting a character string of a morpheme. The UI component is, for example, a textbox.

The display control circuit 25 sets an alphabetic character to each of the UI components (step S3). In the above-described case, the display control circuit 25 sets the alphabetic character A to the UI component for the morpheme “tosha”.

When a large number of the UI components exist (when the number of the UI components exceeds the number of all alphabetic characters), alphabetic character combinations, for example, AA may be set to the UI component or a combination of an alphabetic character and a numeral, for example, A0 may be set to the UI component.

The display control circuit 25 displays in the text correction area 34 the UI components of the respective morphemes of the sentence data and alphabetic characters associated with the UI components (step S4). After the processing in step S4 is completed, a waiting state for a key input via the keyboard 2 begins.

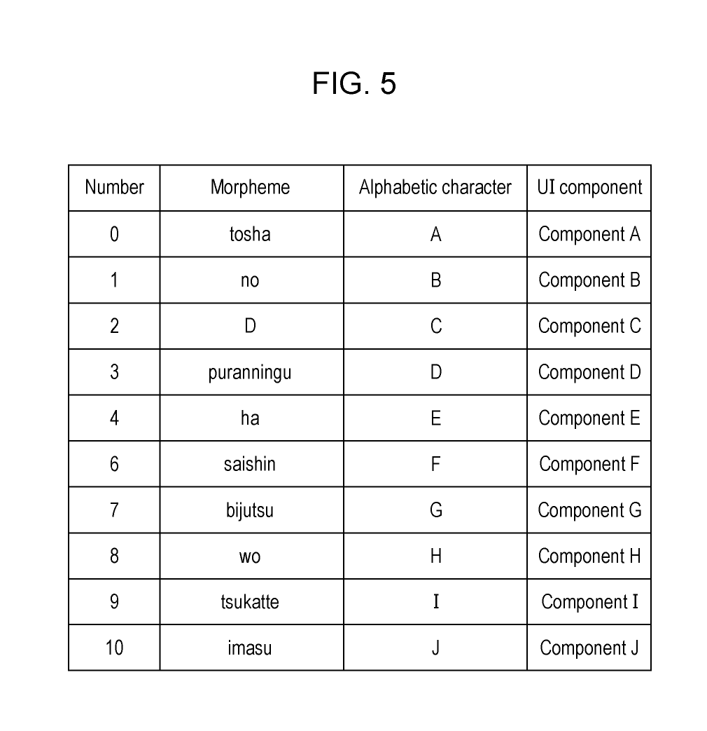

FIG. 5 illustrates an example of a component table. The component table contains fields of number, morpheme, alphabetic character, and UI component. For each number, a morpheme, an alphabetic character, and a UI component are associated with one another. The component table is stored in the memory 12.

The morphological analysis circuit 23 records in the component table multiple morphemes, which are obtained by dividing the selected piece of the sentence data, in association with respective alphabetic characters and the respective UI components. The information in the UI component field in the component table is used for identifying the individual UI components. The morphological analysis circuit 23 associates each morpheme with a unique alphabetic character and a unique UI component.

When displaying the UI components on the screen 30 of the display 3, the display control circuit 25 refers to the component table. The display control circuit 25 displays the alphabetic characters in the guide display area 34G in such a manner as to correspond to the respective morphemes in the text correction area 34.

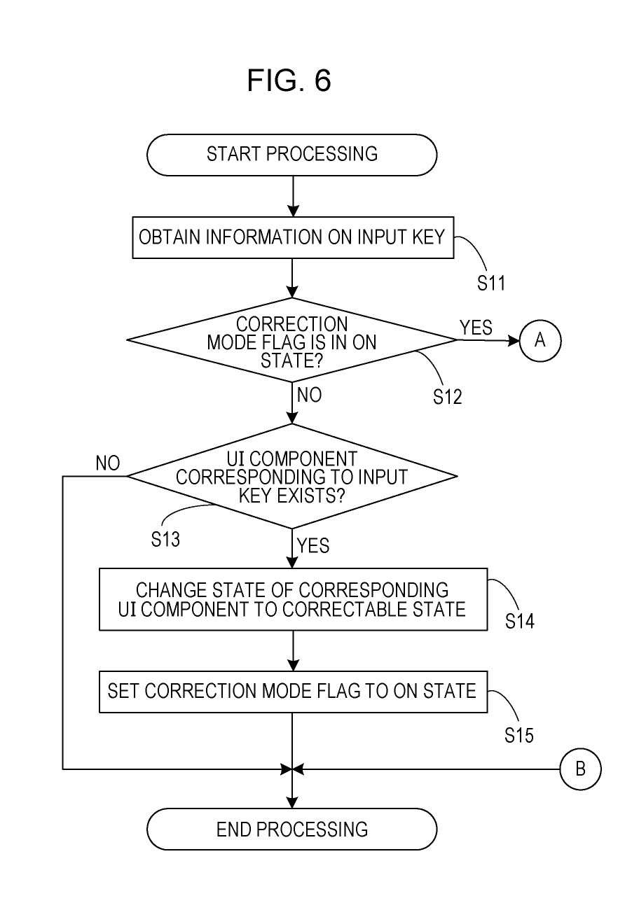

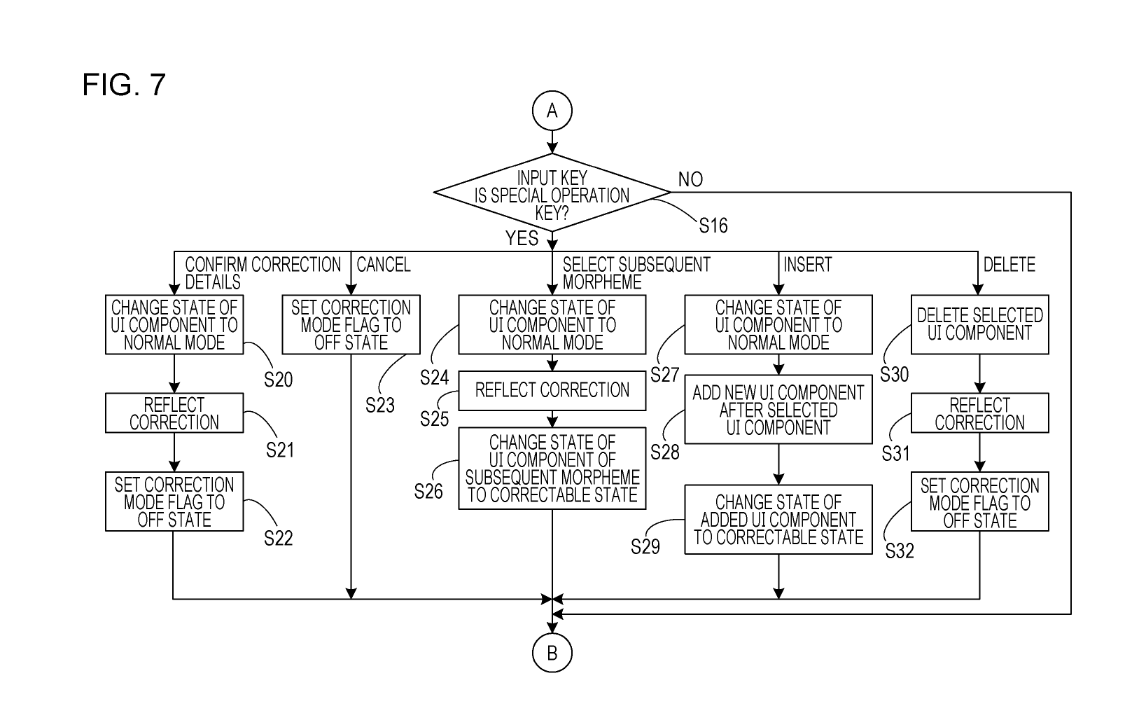

Next, referring to FIG. 6 and FIG. 7, processing when a key is input in a first example is described. At the time of key input, as described above, one piece of the sentence data is selected while in a waiting state for key input via the keyboard 2.

In the above-described waiting state for key input, the UI components for the morphemes of the sentence data remain in the normal mode. When a user inputs any key via the keyboard 2, information indicating the key which is input (information on an input key) is obtained (step S11).

The processing circuit 20 determines whether a correction mode flag is in an ON state (step S12). In a case where the correction mode flag is in the ON state, the UI component corresponding to a particular morpheme is in the correction mode.

If NO in step S12, no UI component corresponding to any of the morphemes is in the correction mode. The processing circuit 20 determines whether the UI component corresponding to the input key exists in accordance with the information on the input key obtained in step S11 (step S13).

For example, in the above-described case, when a key corresponding to any of the shortcut keys of A to J is input via the keyboard 2, the determination result in step S13 is YES. In this case, in accordance with the key input of a shortcut key, the morpheme determination circuit 24 determines a morpheme as a correction target.

If YES in step S13, the processing circuit 20 changes the state of the corresponding UI component to a correctable state (step S14). As a result, the selected morpheme becomes correctable. In the above-described example, when the key G is input, the state of the UI component G of the morpheme “gijutsu” corresponding to the shortcut key G is changed to the correctable state.

The processing circuit 20 sets the correction mode flag to the ON state (step S15). In such a manner, the state of the UI component corresponding to the selected morpheme is changed from the normal mode to the correction mode. Changing the state of the UI component to the correction mode enables correction of a corresponding morpheme.

If NO in step S13, the UI component corresponding to the input key does not exist, and therefore, the processing in steps S14 and S15 is not performed. If NO in step S13 or after the processing in step S15 is completed, the waiting state for key input via the keyboard 2 begins.

If YES in step S12, the correction mode flag is in the ON state and the UI component of a corresponding morpheme is in the correction mode. In this case, the processing flow proceeds to step S16 in FIG. 7 via “A”.

Referring to FIG. 7, the processing following “A” is described. The processing circuit 20 determines whether a key that is input during the correction mode (an input key) is the special operation key in accordance with information on the input key obtained in step S11 (step S16).

The special operation key is set in advance. In the first embodiment, five special operation keys of correction details confirm, cancel, next morpheme select, insert, and delete are set in advance. A separate key is assigned to each of these five special operation keys.

In the above-described example, the tab key is assigned to the special operation key for selecting a subsequent morpheme. A unique key is assigned to each of the other special operation keys. Any number of special operation keys may be used.

If NO in step S16, the input key does not correspond to any special operation key. In this case, the processing flow proceeds to “B” and ends as illustrated in FIG. 6. If NO in step S16, the UI component of the selected morpheme is in the correction mode and the input key does not correspond to any special operation key.

In the above-described case, it is assumed that the key that is input by the user via the keyboard 2 is a key for correcting a morpheme. As a result, the character of the UI component in the correction mode is corrected. While the correction mode flag is in the ON state and keys other than the special operation keys are continuously input, character correction continues.

If YES in step S16 and the input key is a key assigned for confirming correction details, the processing circuit 20 changes the state of the UI component corresponding to the selected morpheme from the correction mode to the normal mode (step S20).

When the special operation key assigned for confirming correction details is input, the correction of the selected morpheme (the UI component of the selected morpheme) has been done. The correction circuit 26 reflects the correction in the selected morpheme (step S21). The processing circuit 20 sets the correction mode flag to an OFF state (step S22). Subsequently, the processing flow moves to “B”.

If YES in step S16 and the input key is a key assigned for cancel, the processing circuit 20 sets the correction mode flag to the OFF state (step S23). Subsequently, the processing flow moves to “B”.

If YES in step S16 and the input key is a key assigned for selecting a subsequent morpheme, the processing circuit 20 changes the state of the UI component corresponding to the selected morpheme to the normal mode (step S24).

The correction circuit 26 reflects the correction of the selected morpheme (step S25). For example, in a case where the selected morpheme is “D”, as described above, the morpheme “D” is changed to “dii”. Due to the correction, the morpheme “D” displayed in the text correction area 34 is accordingly displayed as “dii”.

The processing circuit 20 changes the state of the UI component of a morpheme after the selected morpheme to the correctable state (step S26). For example, since the morpheme after the selected morpheme is “puranningu”, the state of the UI component of the morpheme “puranningu” is changed to the correctable state.

If YES in step S16 and the input key is a key assigned for insert, the processing circuit 20 changes the state of the UI component corresponding to the selected morpheme to the normal mode (step S27).

The processing circuit 20 adds a new UI component after the UI component corresponding to the selected morpheme (step S28). As a result, the content displayed in the text correction area 34 is changed and the content of the component table is also changed. Subsequently, the processing circuit 20 changes the state of the added UI component corresponding to a morpheme to the correctable state (step S29).

If YES in step S16 and the input key is a key assigned for delete, the processing circuit 20 deletes the UI component corresponding to the selected morpheme (step S30). The correction circuit 26 reflects the correction (deletion) in the selected morpheme (step S31).

As a result, the UI component displayed in the text correction area 34 (the UI component of the selected morpheme) is deleted. The processing circuit 20 sets the correction mode flag to the OFF state (step S32). In such a manner, the correction mode is changed to the normal mode. Subsequently, the processing flow moves to “B”.

The processing in FIGS. 6 and 7 is performed when any key on the keyboard 2 is input. When any of the multiple morphemes displayed in the text correction area 34 is selected, the morpheme is determined as a correction target and the state of the corresponding UI component is changed to the correctable state. In such a manner, among multiple morphemes, only the correction-target morpheme is corrected.

When the special operation key is input, the processing corresponding to the input special operation key is performed.

For example, when a key input of the special operation key assigned for selecting a subsequent morpheme is detected after the morpheme “bijutsu” is changed to “gijutsu”, the morpheme determination circuit 24 determines a morpheme corresponding to the shortcut key G as a correction target. The correction circuit 26 reflects the correction in the morpheme in accordance with the correction details based on input via the keyboard 2. Accordingly, the correction of the morpheme corresponding to the shortcut key G in the text correction area 34 is confirmed and the corrected morpheme “gijutsu” is displayed.

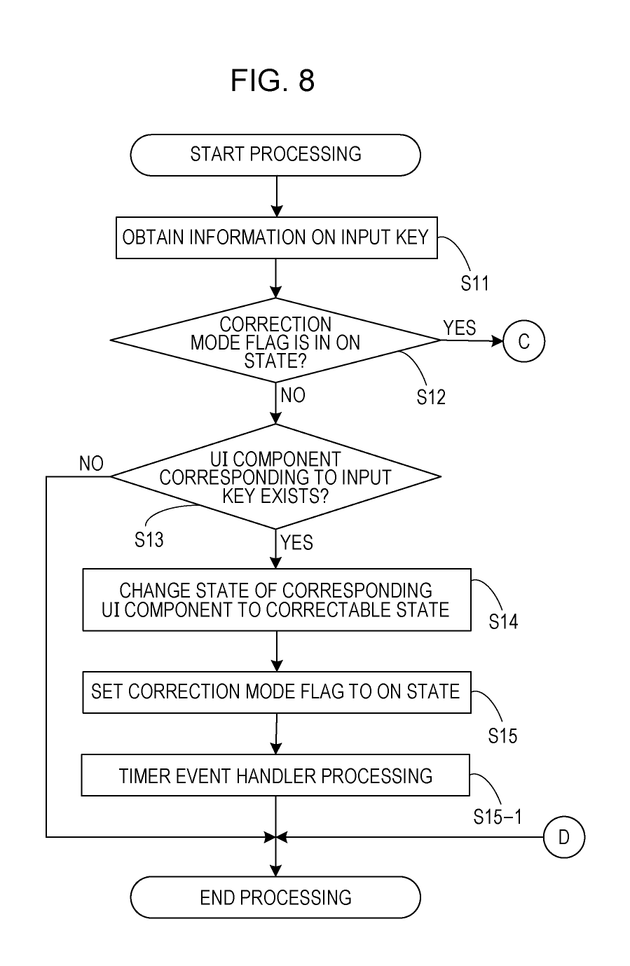

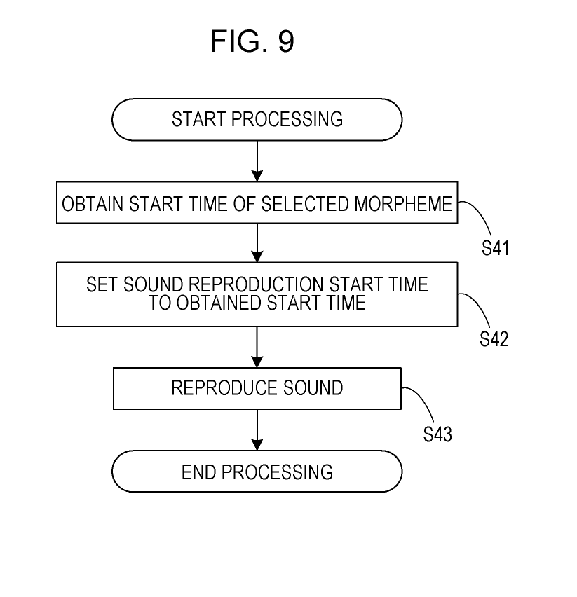

Next, referring to FIG. 8 and FIG. 9, a processing flow when a key is input in a second example is described. The processing in the second example is composed of the processing in the first example and the processing for reproducing sound corresponding to a selected morpheme or multiple consecutive morphemes including the selected morpheme.

In the flowchart in FIG. 8, since steps S11 to S15 are identical to those in the above-described first example, the description is omitted. After the processing in step S15, the interval timer is activated to generate an event at regular intervals (step S15-1).

Referring to a flowchart in FIG. 9, a timer event handler processing flow is described. When the timer event handler processing is performed, the correction-target morpheme is selected and the UI component of the selected morpheme is in the correctable state. The timer event handler 27 refers to a time table stored in the memory 12 and obtains a start time at which the selected morpheme starts (step S41).

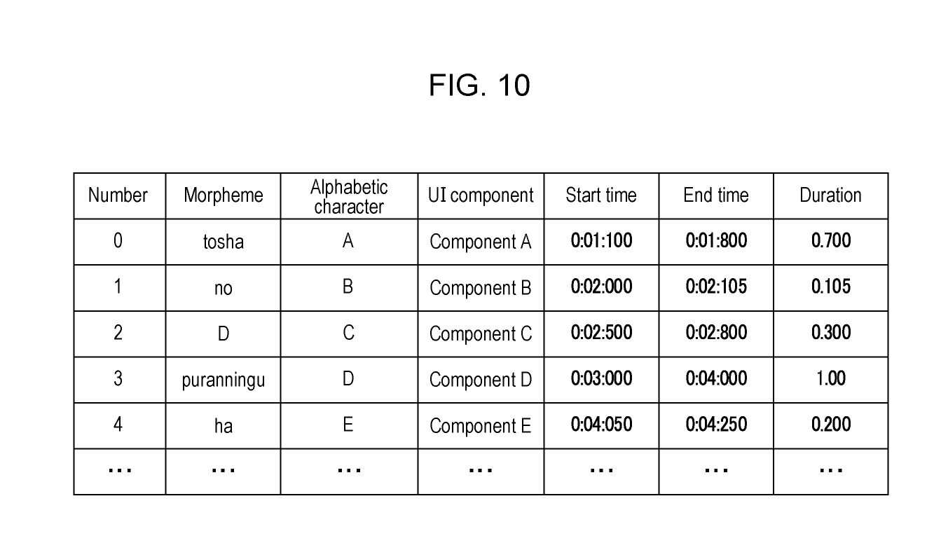

FIG. 10 illustrates an example of the time table. The time table is stored in the memory 12 and contains fields of number, morpheme, alphabetic character, UI component, start time, end time, and duration.

Number, morpheme, alphabetic character, and UI component are the same as in the above-described component table. Start time indicates a start time of sound corresponding to a morpheme in audio contained in moving image data. End time indicates an end time of sound corresponding to a morpheme in audio contained in moving image data. Duration indicates duration between a start time and an end time.

As illustrated in FIG. 9, the timer event handler 27 sets a sound reproduction start time to the start time obtained in step S41 (step S42). As a result, the sound reproduction start time is set to the start time of sound of the selected morpheme.

The sound reproduction control circuit 29 refers to the end time in the time table and controls the audio contained in the moving image data to be reproduced from the sound reproduction start time that is set in step S42 to the end time of the selected morpheme (step S43). As a result, the sound corresponding to the selected morpheme is reproduced by the speaker 4. At this time, the moving image data may be reproduced.

The interval timer for invoking the timer event handler 27 at regular intervals is provided to the text correction apparatus 1. The timer event handler 27 is invoked at regular intervals, and the processing in FIG. 9 is performed. As a result, the sound corresponding to the selected morpheme is repeatedly reproduced by the speaker 4.

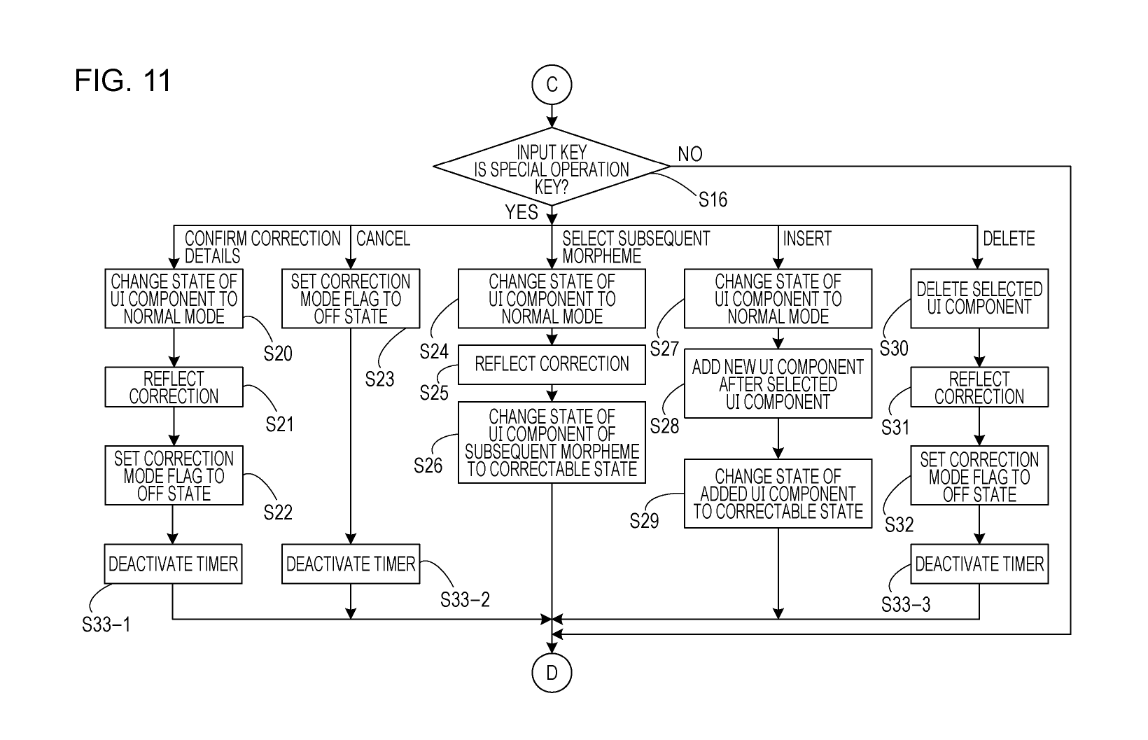

FIG. 11 is a flowchart illustrating a processing flow from “C” to “D” in FIG. 8. Since steps S20 to S32 are identical to those in the above-described first example, the description is omitted. If an input of the special operation key for confirming correction details is detected while the correction mode flag is in the ON state, the interval timer is deactivated (step S33-1).

The timer event handler 27 is not invoked after the interval timer is deactivated in step S33-1.

By performing the above-described timer event handler processing, the sound corresponding to the selected morpheme is repeatedly reproduced. The user corrects the selected morpheme by using the keyboard 2. Reproducing the sound corresponding to the correction-target morpheme on the speaker 4 while the user is correcting the morpheme enables the user to more easily understand the sound corresponding to the morpheme.

After the correction details are confirmed, it is not desired that the sound corresponding to the selected morpheme is repeatedly reproduced by the speaker 4. Therefore, the interval timer is deactivated in step S33-1.

In a case where the selected morpheme is cancelled, it is not desired that the sound corresponding to the selected morpheme is repeatedly reproduced by the speaker 4. Therefore, the interval timer is deactivated after step S23 (step S33-2).

In a case where the selected morpheme is deleted, it is not desired that the sound corresponding to the selected morpheme is repeatedly reproduced by the speaker 4. Therefore, the interval timer is deactivated after step S32 (step S33-3).

In the above-described example, the sound corresponding to the selected morpheme is repeatedly reproduced, but the sound corresponding to multiple morphemes including the selected morpheme may be reproduced. For example, the timer event handler 27 may control reproduction of the sound corresponding to the selected morpheme and a predetermined number of morphemes before and after the selected morpheme.

In this case, the timer event handler 27 refers to the time table and specifies an earliest start time and a latest end time with respect to the predetermined number of morphemes before and after the selected morpheme. The sound reproduction control circuit 29 controls the sound corresponding to the multiple morphemes from the earliest start time to the latest end time to be reproduced by the speaker 4. In such a manner, the sound corresponding to the selected morpheme and the predetermined number of morphemes before and after the selected morpheme is reproduced by the speaker 4.

Reproduced not only the sound corresponding to the selected morpheme but also the sound corresponding to the predetermined number of morphemes before and after the selected morpheme on the speaker 4 enables the user to grasp the context containing the selected morpheme. For example, when only the sound corresponding to the selected morpheme is reproduced by the speaker 4, only the sound of “bijutsu” is repeatedly reproduced.

Conversely, when not only the sound corresponding to the selected morpheme but also the sound corresponding to morphemes before and after the selected morpheme is reproduced, the sound of “saishinbijutsuwo” is repeatedly reproduced. By listening to the sound of “saishin bijutsu wo” reproduced by the speaker 4, the user more easily understands that the morpheme of “bijutsu” is correctly “gijutsu”.

The sound reproduction control circuit 29 may control reproduction of whole sentence data or multiple morphemes from the start of the sentence data to the selected morpheme. The number of morphemes targeted for reproduction controlled by the sound reproduction control circuit 29 may be any number.

The sound reproduction control circuit 29 may reproduce the selected morpheme at a speed lower than a normal speed. For example, by reproducing the sound corresponding to the selected morpheme “bijutsu” at a low speed on the speaker 4, the user more easily understand the morpheme “bijutsu”.

Next, processing when a key is input in a third example is described. The third example is an example of presenting a correction candidate for the selected morpheme. The correction candidate is calculated by the correction-candidate calculation circuit 28 in accordance with the learned model obtained by machine learning that uses the past sentence data as input data.

As the machine learning technique, for example, Sequence-to-Sequence may be employed. Sequence-to-Sequence is a type of machine learning technique that utilizes a recurrent neural network (RNN) and suitable for calculating a word order. The learned model may be generated by employing any machine learning technique other than Sequence-to-Sequence.

For example, it is assumed that the learned model is generated by employing the Sequence-to-Sequence machine learning that uses as input data a large amount of past sentence data stored on a database (for example, a past article database or a television caption database) outside the text correction apparatus 1.

The communication circuit 13 may obtain the learned model from, for example, an external device or an external database via a network and the memory 12 may store the obtained learned model. The text correction apparatus 1 may perform the above-described machine learning and stores the learned model in the memory 12.

The correction-candidate calculation circuit 28 obtains the learned model that is generated by employing the Sequence-to-Sequence machine learning and that is stored in the memory 12. The correction-candidate calculation circuit 28 calculates a correction candidate for the selected morpheme by using the learned model in accordance with the order of morphemes in the selected piece of the sentence data.

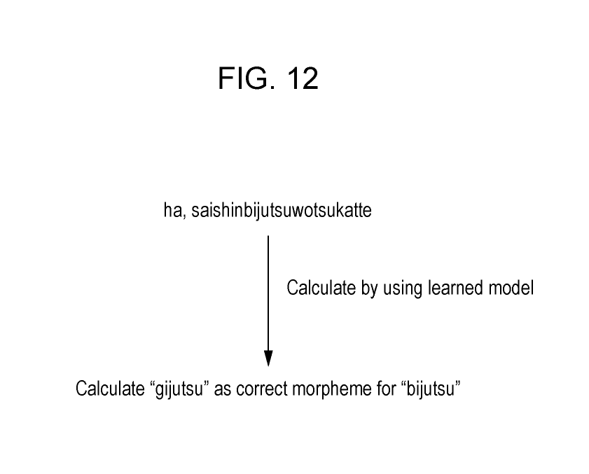

As illustrated in FIG. 12, the correction-candidate calculation circuit 28 calculates by using the obtained learned model the most probable order as follows: “ha” “saishin” “gijutsu” “wo” “tsukatte”. As a result, the correction-candidate calculation circuit 28 calculates a correction candidate “gijutsu” for the selected morpheme “bijutsu”.

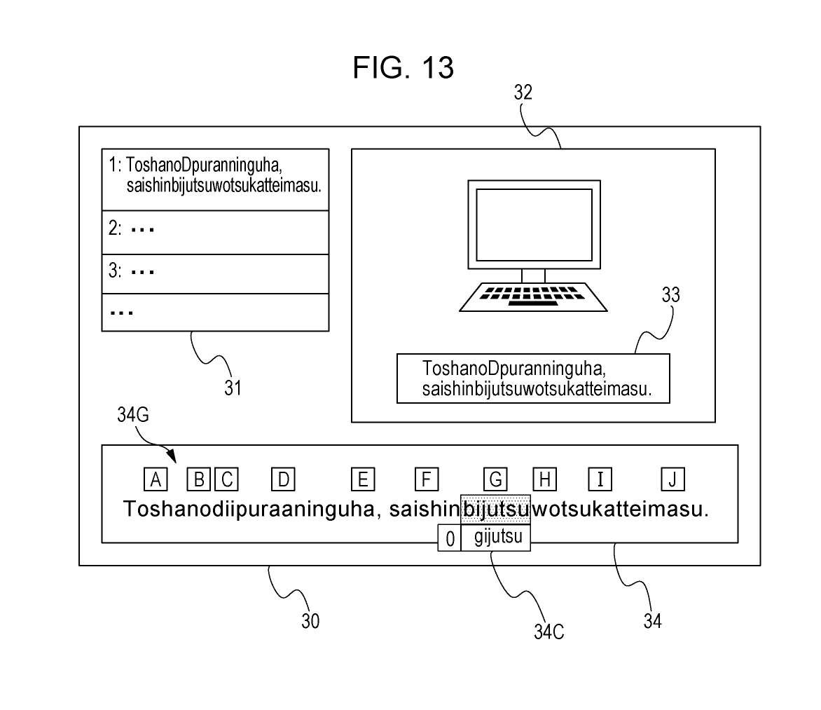

The display control circuit 25 controls display of the correction candidate in such a manner as to correspond to the selected morpheme in the text correction area 34. As illustrated in an example in FIG. 13, a correction-candidate selection instruction (a numeric key 0) for selecting the correction candidate “gijutsu” is displayed together with the correction candidate “gijutsu”. When multiple correction candidates exist, different correction-candidate selection instructions (for example, different numeric keys) may be displayed in relation to the respective multiple correction candidates.

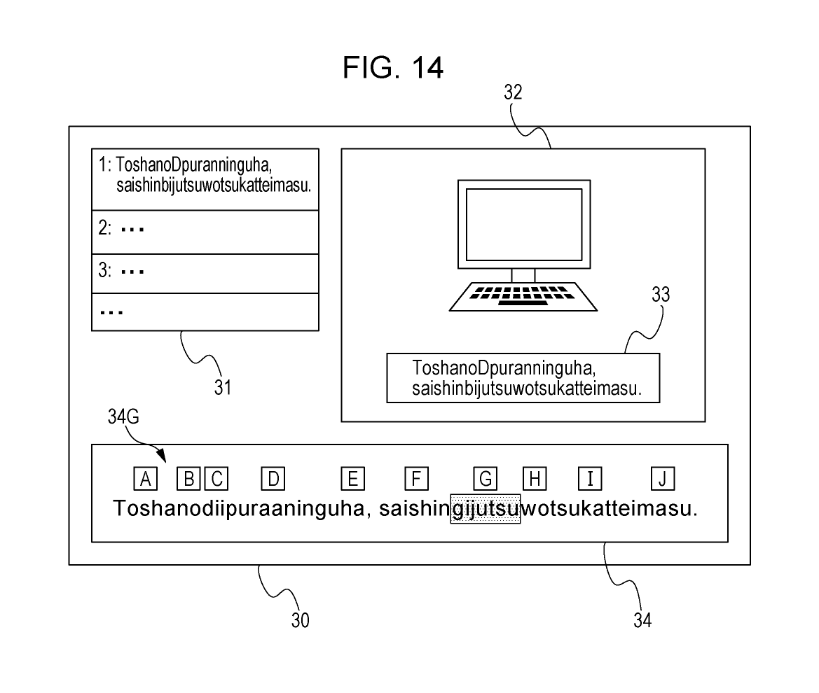

In the example in FIG. 13, the user inputs the numeric key 0 via the keyboard 2 and the input is detected, and as a result, the correction candidate “gijutsu” is confirmed. FIG. 14 illustrates an example of a screen after the confirmation. In the third example, the calculated correction candidate for the selected morpheme is displayed.

In such a manner, when correcting the selected morpheme, the user only has to select a correction candidate by using the keyboard 2, as a result, it is not desired that the user inputs keys for inputting correction details, thereby reducing the workload for correcting the result of transcript generation.

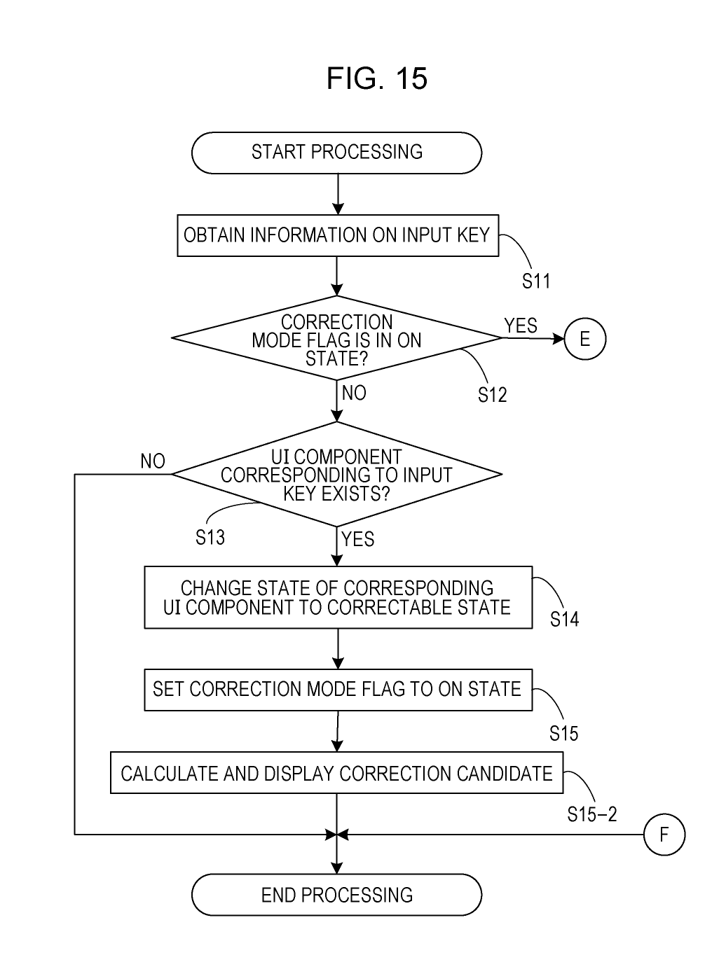

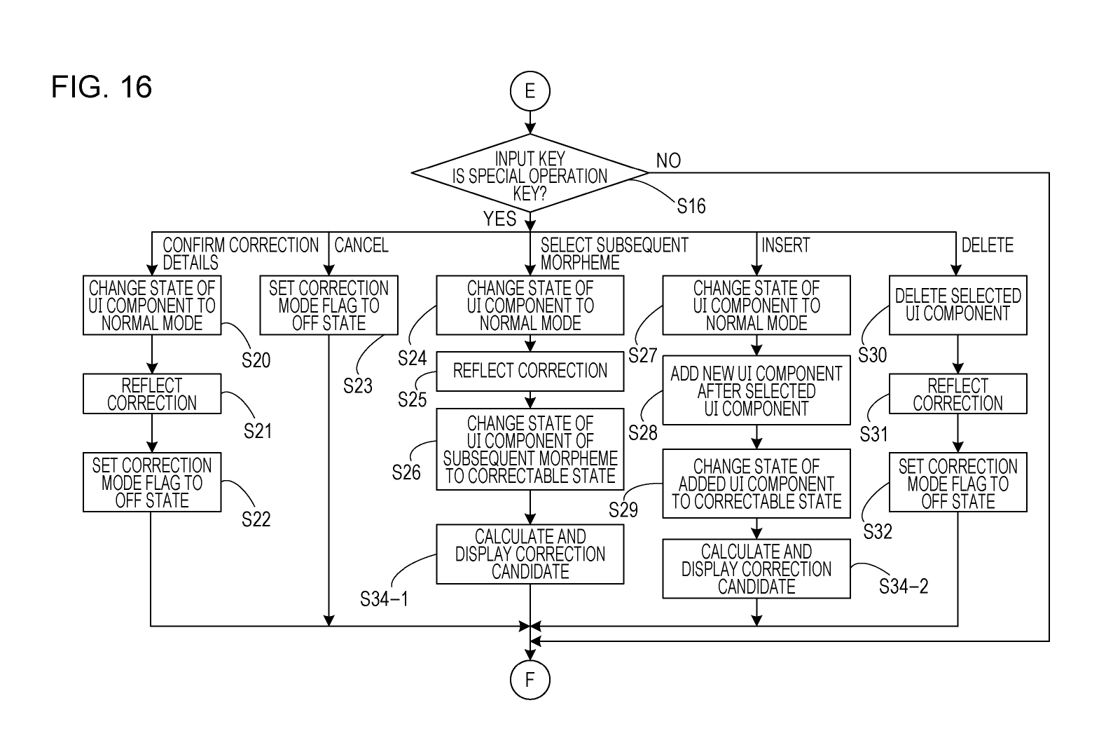

Referring to FIGS. 15 and 16, a processing flow when a key is input in the third example is described. In a flowchart in FIG. 15, since steps S11 to S15 are identical to those in the above-described first and second examples, the description is omitted.

After the processing in step S15, the correction-candidate calculation circuit 28 calculates a correction candidate for the selected morpheme by using the above-described learned model in accordance with the order of morphemes and the display control circuit 25 controls the correction candidate to be displayed in the text correction area 34 (step S15-2).

In a flowchart in FIG. 16, since steps S20 to S32 are identical to those in the above-described first and second examples, the description is omitted.

In the flowchart in FIG. 16, after the processing in step S26, the same processing as in step S15-2 (the processing for calculating and displaying a correction candidate) is performed (step S34-1). Likewise, after the processing in step S29, the same processing as in step S15-2 (the processing for calculating and displaying a correction candidate) is performed (step S34-2).

When a morpheme subsequent to the selected morpheme is corrected or when an inserted morpheme is corrected, since a new morpheme is to be corrected, it is preferable that a correction candidate be displayed.

Conversely, when the special operation key for confirming correction details, the special operation key for cancel is input, or the special operation key for delete is input, since no new morpheme is to be corrected, it is not desired to perform processing for displaying a correction candidate.

### Second Embodiment

Next, a second embodiment is described. The configuration of the text correction apparatus 1 in the second embodiment is identical to that of the first embodiment illustrated in FIG. 1. In the second embodiment, in response to the reproduction of speech data contained in moving image data, the display control circuit 25 displays in an operable state (e.g., by displaying in an emphasized manner) a particular morpheme that appears a predetermined number of morphemes before the morpheme being reproduced.

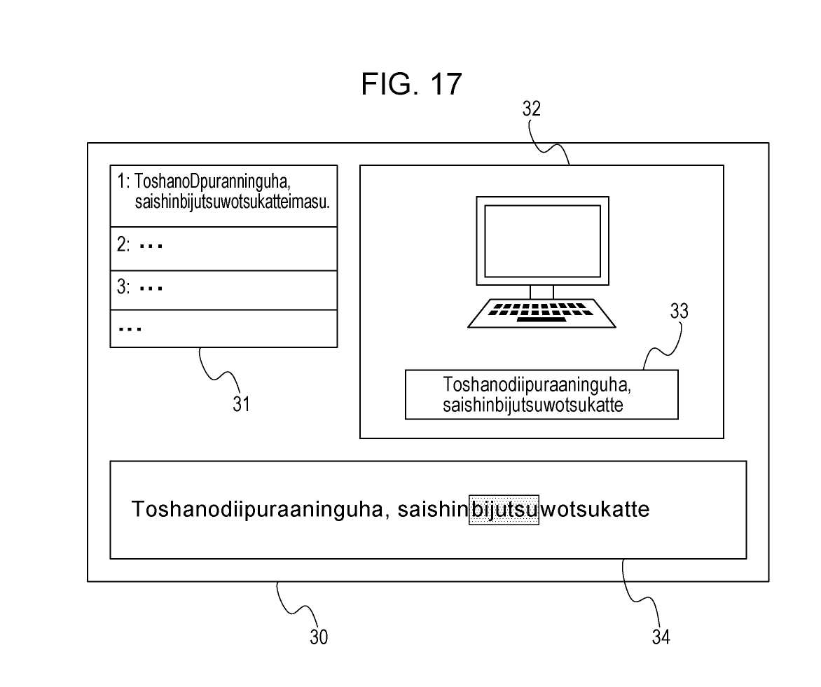

As illustrated in FIG. 17, the display control circuit 25 displays morphemes from the beginning of the sentence data to the morpheme whose corresponding sound is being reproduced in the text display area 33 of the screen 30. While displaying morphemes from the beginning of the sentence data to the morpheme whose corresponding sound is being reproduced, the display control circuit 25 changes a display mode of a particular morpheme that appears a predetermined number of morphemes before the morpheme whose corresponding sound is being reproduced. In the following description, it is assumed that the display mode is changed to a display mode in an emphasized manner (for example, change in color or change in a background color) in which a morpheme is displayed in the text correction area 34 as described above.

In an example in FIG. 17, the morpheme whose corresponding sound is being reproduced is “tsukatte” and the display mode of the morpheme “bijutsu”, which is the morpheme two (a predetermined number) morphemes before the morpheme “tsukatte” whose corresponding sound is being reproduced, is changed. As the speech reproduction proceeds, the morpheme whose corresponding sound is being reproduced is changed to following morphemes and the morpheme being displayed in an emphasized manner is also changed to following morphemes.

In a state in which the morpheme “bijutsu”, which is the morpheme two morphemes before the morpheme whose corresponding sound is being reproduced “tsukatte”, is displayed in an emphasized manner as illustrated in the example in FIG. 17, when a predetermined operation for the keyboard 2 is detected, the morpheme determination circuit 24 determines the morpheme “bijutsu” as a correction target. As a result, the morpheme “bijutsu” becomes correctable.

For example, while the morpheme “bijutsu” is displayed in an emphasized manner, when an input of a predetermined key (for example, an enter key) is detected, the morpheme determination circuit 24 determines the morpheme “bijutsu” as a correction target. In such a manner, the morpheme “bijutsu” becomes correctable. While the morpheme “bijutsu” is in the correctable state, the sound reproduction control circuit 29 controls reproduction of sound corresponding to the correction-target morpheme “bijutsu” in a repeated manner and at a low speed.

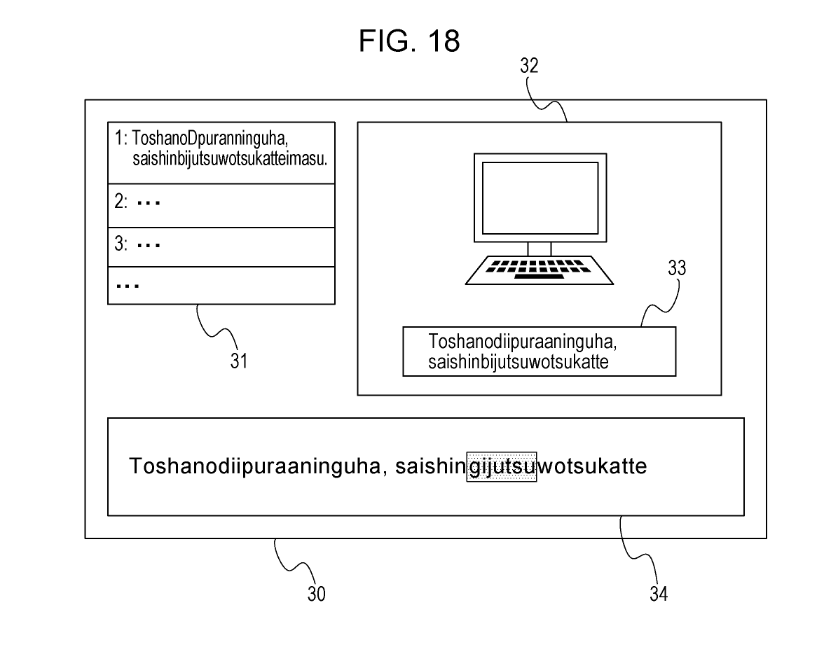

The user corrects the morpheme “bijutsu” by using the keyboard 2. At this time, the morpheme “bijutsu” is reproduced by the speaker 4 in a repeated manner and at a low speed. If the user inputs “gijutsu” by using the keyboard 2, the morpheme “bijutsu” is changed to “gijutsu” as illustrated in FIG. 18.

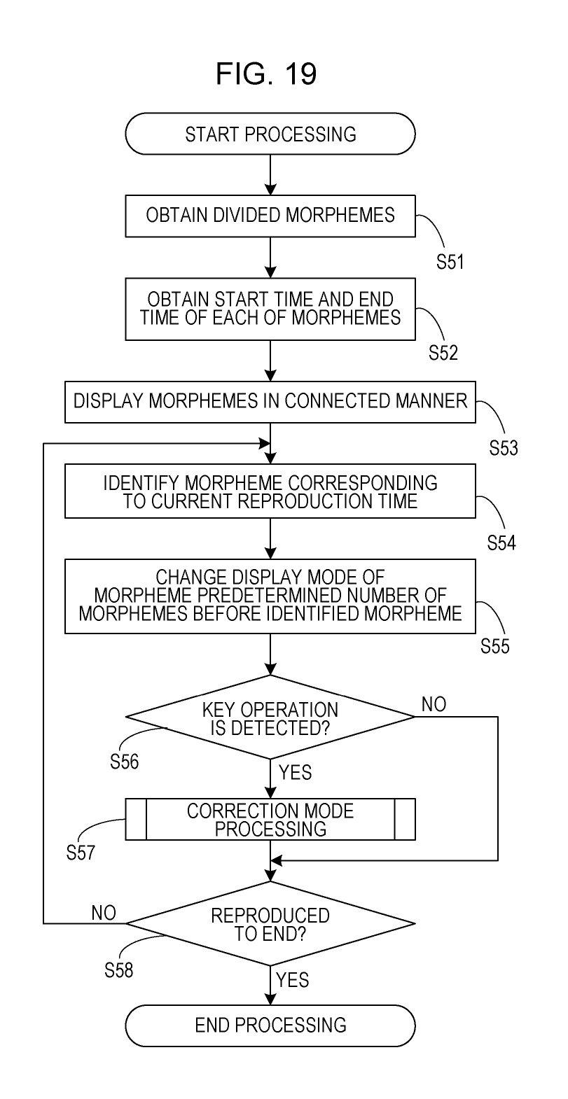

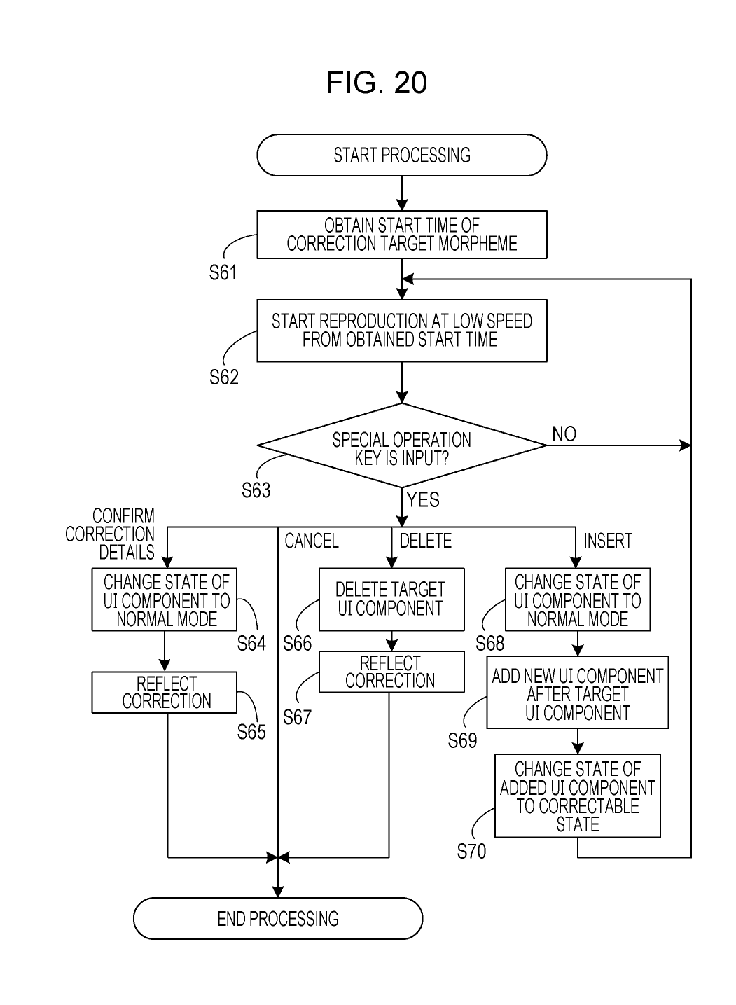

FIGS. 19 and 20 are flowcharts illustrating processing flows in the second embodiment. The processing circuit 20 obtains from the memory 12 divided morphemes stored in the memory 12 (step S51).

The processing circuit 20 refers to the time table stored in the memory 12 and obtains a start time and an end time of each of the morphemes (step S52). The display control circuit 25 connects the morphemes obtained in step S51 together in order (step S53).

The processing circuit 20 refers to the time table and identifies a morpheme corresponding to the current reproduction time (step S54). The display control circuit 25 changes the display mode of a morpheme a predetermined number of morphemes before the identified morpheme (step S55).

The processing circuit 20 determines whether an input operation of a predetermined key on the keyboard 2 is detected (step S56). If YES in step S56, correction mode processing is performed (step S57). If NO in step S56, the correction mode processing is not performed. If YES in step 58, processing is finished. If NO in step 58, processing returned to step 54.

Next, referring to FIG. 20, the correction mode processing in step S57 is described. When the correction mode processing starts, the correction-target morpheme is determined by the morpheme determination circuit 24.

The processing circuit 20 refers to the time table and obtains the start time of a morpheme (a morpheme whose display mode has been changed) a predetermined number of morphemes before the morpheme identified in step S54 (step S61).

The sound reproduction control circuit 29 controls reproduction of sound corresponding to the morpheme whose display mode has been changed at a low speed from the start time obtained in step S61 (step S62). According to the control, the sound corresponding to the morpheme is reproduced by the speaker 4. Since the sound corresponding to the morpheme is reproduced at a low speed by the speaker 4, the user more easily understand the sound corresponding to the correction-target morpheme.

The sound reproduction control circuit 29 may control reproduction of sound corresponding to not only the morpheme displayed in an emphasized manner but also multiple morphemes before and after the morpheme. In this case, the sound corresponding to the multiple consecutive morphemes including the morpheme is reproduced by the speaker 4.

The sound reproduction control circuit 29 may control reproduction of sound corresponding to the morpheme displayed in an emphasized manner or multiple consecutive morphemes including the morpheme and morphemes before and after the morpheme at a normal speed. The display control circuit 25 may also display a slider bar that adjusts the speed of reproduction on the screen 30.

In accordance with a user operation with the slider bar, the sound reproduction control circuit 29 reproduces the sound corresponding to the morpheme displayed in an emphasized manner or multiple consecutive morphemes including the morpheme and morphemes before and after the morpheme at an arbitrary reproduction speed.

The processing circuit 20 determines whether the special operation key is input (step S63). If NO in step S63, the processing flow moves to step S62. In such a manner, the sound corresponding to the morpheme displayed in an emphasized manner or the sound corresponding to multiple consecutive morphemes including the morpheme and morphemes before and after the morpheme is repeatedly reproduced.

If YES in step S63 and the input key is the key for confirming correction details, the processing circuit 20 changes to the normal mode the state of the UI component corresponding to the morpheme whose display mode has been changed (step S64).

When the special operation key assigned for confirming correction details is input, the correction of the morpheme displayed in an emphasized manner is confirmed, and accordingly, the correction circuit 26 reflects the correction in the selected morpheme (step S65).

If YES in step S63 and the input key is the key assigned for cancel, the correction is cancelled, and as a result, the correction mode processing ends.

If YES in step S63 and the input key is the key assigned for delete, the processing circuit 20 deletes the UI component corresponding to the morpheme displayed in an emphasized manner (step S66). The correction circuit 26 reflects the correction (deletion) in the selected morpheme (step S67). As a result, the UI component displayed in the text correction area 34 is deleted.

If YES in step S63 and the input key is the key assigned for insert, the processing circuit 20 changes the state of the UI component corresponding to the morpheme displayed in an emphasized manner to the normal mode (step S68).

The processing circuit 20 subsequently adds a new UI component after the UI component corresponding to the morpheme displayed in an emphasized manner (step S69). As a result, the content displayed in the text correction area 34 is changed and the content of the component table is also changed. The processing circuit 20 changes the state of the added UI component corresponding to a morpheme to the correctable state (step S70).

After the processing in step S70 is performed, the correction target is changed to the newly added UI component and the processing flow moves to step S62.

Example of hardware configuration of text correction apparatus

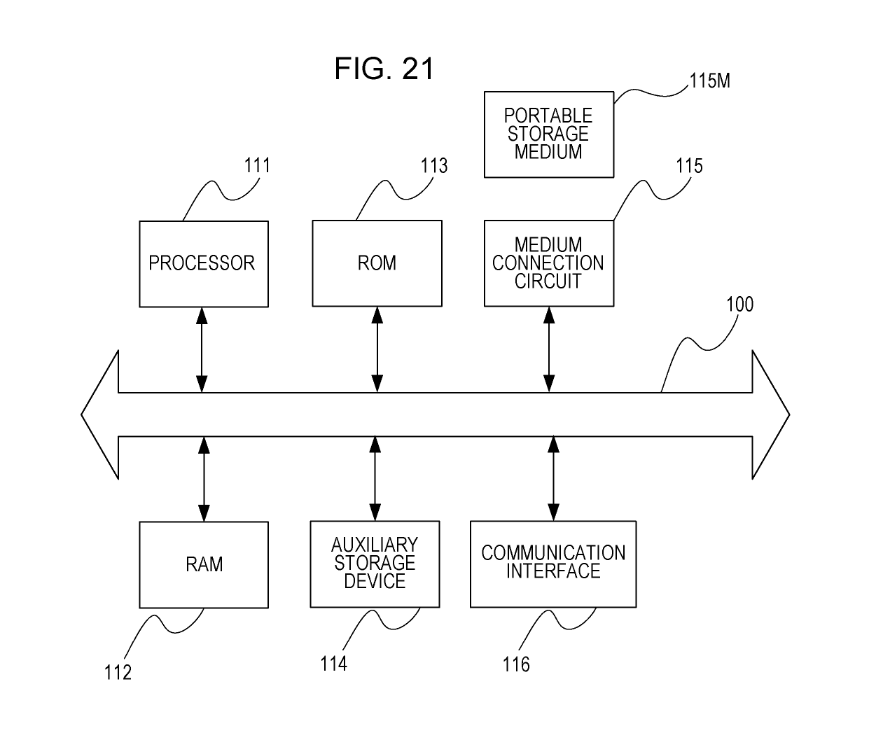

Next, referring to an example in FIG. 21, an example of a hardware configuration of the text correction apparatus 1 is described. As illustrated in FIG. 21, a processor 111, a random access memory (RAM) 112, a read only memory (ROM) 113 are coupled to a bus 100. An auxiliary storage device 114, a medium connection circuit 115, a communication interface 116 are also coupled to the bus 100.

The processor 111 executes a program loaded into the RAM 112. As a program to be executed, a text correction program for performing the processing in the embodiments may be applied.

The ROM 113 is a non-volatile storage device that stores the text correction program to be loaded into the RAM 112. The auxiliary storage device 114 is a storage device that stores various kinds of information and, for example, a hard disk drive or a semiconductor memory may be used as the auxiliary storage device 114. The medium connection circuit 115 is provided such that a portable storage medium 115M is connectable to the medium connection circuit 115.

As the portable storage medium 115M, a portable memory (for example, an optical disc or a semiconductor memory) may be applied. The portable storage medium 115M may record the text correction program that performs the processing in the embodiments.

Each portion of the control circuit 11 may be implemented by the processor 111 executing the provided text correction program. The memory 12 may be implemented as the RAM 112, the auxiliary storage device 114, or the like. The communication circuit 13 may be implemented as the communication interface 116.

The RAM 112, the ROM 113, the auxiliary storage device 114, and the portable storage medium 115M are examples of a computer-readable tangible storage medium. The computer-readable tangible storage medium does not include a temporal medium, such as a signal carrier wave.

Others

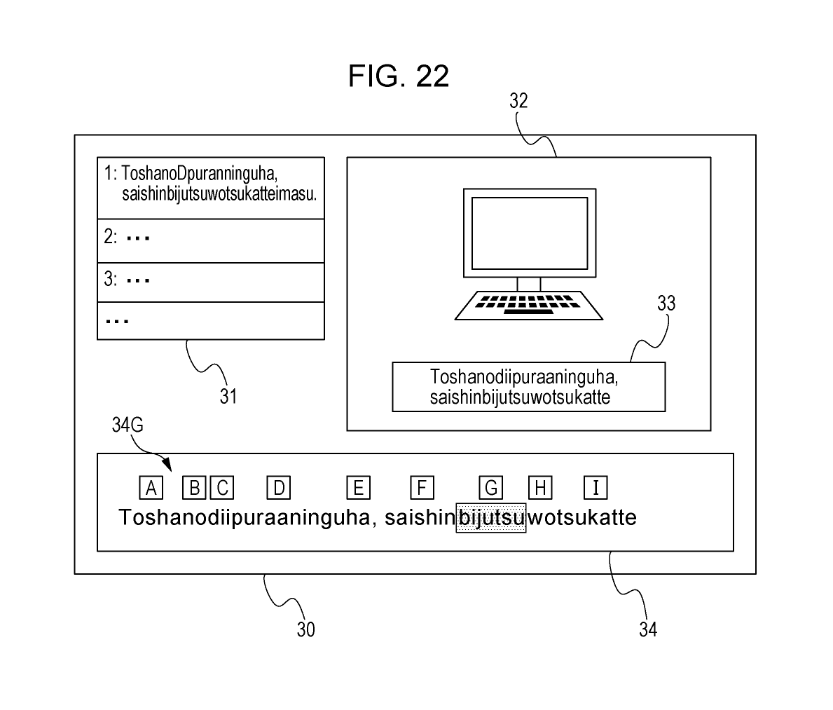

The text correction apparatus 1 may have both the function of the first embodiment and the function of the second embodiment. FIG. 22 illustrates an example of the screen 30 in a case where both the first embodiment and the second embodiment are applied.

As illustrated in FIG. 22, shortcut keys are displayed in association with respective morphemes in the text correction area 34. In the example in FIG. 22, the speech has been reproduced up to “tsukatte”.

When a key input corresponding to any shortcut key is detected, as described in the first embodiment, a morpheme corresponding to the shortcut key is identified and the identified morpheme becomes correctable.

While the morpheme “bijutsu”, which is the morpheme two morphemes before the morpheme “tsukatte” whose corresponding sound is being reproduced, is displayed in an emphasized manner, when a predetermined input (for example, an input of the enter key) via the keyboard 2 is detected, the morpheme “bijutsu” displayed in an emphasized manner is determined as a correction-target morpheme. As a result, the correction-target morpheme becomes correctable.

The first and second embodiments are not limited to the above-described modes and a variety of configurations or embodiments may be applied without departing from the scope of the first and second embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A text correction apparatus comprising:
a memory; and
a processor coupled to the memory and configured to:
divide sentence data recognized from speech data into a plurality of text units,
when selection of one text unit among the plurality of divided text units is input via an input device, determine the selected text unit as a correction target,
display the selected text unit in a correctable state on a display device, and
reflect correction in the sentence data on the display device in accordance with correction of the selected text unit.

2. The text correction apparatus according to claim 1, wherein the processor is configured to:
control the display device to display multiple kinds of identification information for identifying the plurality of text units, and
when an operation for selecting one of the multiple kinds of identification information via the input device is detected, determine one of the plurality of text units corresponding to the detected one of the multiple kinds of identification information as a correction target.

3. The text correction apparatus according to claim 1, wherein the processor is further configured to:
display the sentence data on the display device in accordance with sound reproduced from the speech data, the sound corresponding to the plurality of text units;
control the display of the sentence data to visually emphasize a first text unit that appears a predetermined number of text units before a second text unit being displayed in accordance with the reproduced sound corresponding to the second text unit; and
detect a selection of the first text unit as the selected text unit for the correction target.

4. The text correction apparatus according to claim 1,
wherein the processor is configured to change a display mode of the text unit among the plurality of text units as the correction target on the display device.

5. The text correction apparatus according to claim 1,
wherein the processor is configured to reflect the correction in the sentence data by overwriting the selected text unit among the plurality of text units.

6. The text correction apparatus according to claim 1, wherein the processor is configured to:
calculate a correction candidate for the text unit as the correction target among the plurality of text units of the sentence data in accordance with a learned model obtained by machine learning that uses an order of plurality of past text units as input data, and
control the display device to display the correction candidate in association with the text unit as the correction target.

7. The text correction apparatus according to claim 1,
wherein the processor is configured to control repeated reproduction of sound corresponding to the text unit selected via the input device and a predetermined number of text units before and after the selected text unit among the plurality of text units.

8. The text correction apparatus according to claim 7, wherein the processor is configured to control a reproduction speed to be a low speed when repeatedly reproducing the sound.

9. A text correction method executed by a processor included in a text correction apparatus, the method comprising:
dividing sentence data recognized from speech data into a plurality of text units;
determining a selected text unit as a correction target;
when selection of one text unit among the plurality of divided text units is input via an input device, displaying the selected text unit in a correctable state on a display device; and
displaying correction in the sentence data in accordance with correction of the selected text unit.

10. The text correction method according to claim 9, further comprising:
displaying on the display device multiple kinds of identification information for identifying the plurality of text units; and
when an operation for selecting one of the multiple kinds of identification information via the input device is detected, determining one of the plurality of text units corresponding to the detected one of the multiple kinds of identification information as a correction target.

11. The text correction method according to claim 9, further comprising:
displaying the sentence data on the display device in accordance with sound reproduced from the speech data, the sound corresponding to the plurality of text units;
controlling the display of the sentence data to visually emphasize a first text unit that appears a predetermined number of text units before a second text unit being displayed in accordance with the reproduced sound corresponding to the second text unit;
detecting a selection of the first text unit as the selected text unit for the correction target.

12. The text correction method according to claim 9, further comprising:
changing a display mode of the text unit among the plurality of text units as the correction target on the display device.

13. The text correction method according to claim 9, further comprising:
calculating a correction candidate for the text unit as the correction target among the plurality of text units of the sentence data in accordance with a learned model obtained by machine learning that uses an order of plurality of past text units as input data; and
displaying on the display device the correction candidate in association with the text unit as the correction target.

14. The text correction method according to claim 9, further comprising:
controlling repeated reproduction of sound corresponding to the text unit selected via the input device and a predetermined number of text units before and after the selected text unit among the plurality of text units.

15. The text correction method according to claim 14, further comprising:
controlling a reproduction speed to be a low speed when repeatedly reproducing the sound.

16. A non-transitory computer-readable recording medium storing a program that causes a processor included in a text correction apparatus to execute a process, the process comprising:
dividing sentence data recognized from speech data into plurality of text units;
determining a selected text unit as a correction target, when selection of one text unit among the plurality of divided text units is input via an input device;
displaying the selected text unit in a correctable state on a display device; and
displaying correction in the sentence data in accordance with correction of the selected text unit.

17. A text correction method executed by a processor, the method comprising:
obtaining sentence data transcribed from speech data;
dividing the sentence data obtained into a plurality of text units;
providing an identification component corresponding to each of the plurality of text units;
receiving a selection of one of the plurality of text units based on a selection of the identifying component corresponding to the selected one text unit;
receiving a change to a content of the selected one text unit;
revising the sentence data to reflect the changed content of the selected one text unit in the sentence data;
displaying the revised sentence data.
